(19) United States
(12) Patent Application Publication
(10) Pub. No.: US 2006/0055974 A1
(43) Pub. Date: Mar. 16, 2006

(54) Printing system and job control method therefor

(75) Inventor: Katsuya Yamaguchi, Kyoto (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD

(21) Appl. No.: 11/221,822

(22) Filed: Sep. 9, 2005

(30) Foreign Application Priority Data
Sep. 10, 2004 (JP) P2004-263304

(51) Int. Cl. G06K 15/00

(52) U.S. Cl. 358/1.16; 358/1.15

(57) ABSTRACT

In a printing system, while printing preceding job A (PR11), RIP processing on print data for succeeding job B is completed, so that data used for printing the succeeding job B is made ready for printing (T202), and thereafter it is determined whether or not the paper size for the succeeding job B is the same as that for the preceding job A (T204). If they are the same in paper size, a successive instruction Ic is transmitted to a printer that is executing the printing of the job A (T208). Upon receipt of the successive instruction Ic, the printer executes printing of the job B, which is a job succeeding the job A, successively after the printing of the job A is completed, without ceasing the operation of the printing mechanism. Thus, it is possible to reduce idle time during a printing/output operation between jobs for printing.

### BACKGROUND OF THE INVENTION

1. Field of Technology

The present invention relates to a printing system including: storage means, such as a memory and a disk drive, which temporarily store, in units of predetermined jobs, print data subjected to rasterization processing or the like so as to become ready for printing; and a printing means allowed to perform printing in units of jobs based on the print data stored in the storage means. More particularly, the present invention relates to job control for performing printing in units of jobs in such a printing system.

2. Description of Related Art

Printing systems for printing publications and the like include a memory or a disk drive, which temporarily stores print data subjected to rasterization processing or the like so as to become ready for printing. In such printing systems, for example, execution of printing is managed or controlled in units of jobs each corresponding to printing of a predetermined number of copies of a document such as a publication. Specifically, the print data ready for printing is stored in units of jobs into a storage means such as a memory or a disk drive, and the print data is read in units of jobs from the storage means for executing printing. Such a printing device performs jobs based on print data storable within the capacity limit of the storage means, such as a memory or a disk drive, such that printing/output operations for the jobs can be successively carried out by detecting the presence or absence of the print data.

However, in the case where a single job involves printing of a document containing a number of pages or a number of jobs are involved, print data for one or plurality of jobs desired to be successively printed might not be completely stored into the memory or disk drive. In such a case, the printing device executes a printing completion cycle upon completion of printing corresponding to print data for the last job stored in the memory or disk drive, and therefore, idling occurs before the next job during a printing/output operation. For example, in the case where a printing system as shown in FIG. 12, which consists of an electrophotographic printer 600 and a controller 500 therefor, successively prints two jobs A and B, an idling section φ in which no printing/output operation is carried out occurs between the jobs A and B in a (notional) paper conveyance path as shown in FIG. 13 due to execution of a printing completion cycle. The idling section φ corresponds to idle time for which no printing/output operation is carried out, and causes a reduction in throughput of the printing system.

Also, in electrophotographic printing devices, when no printing paper is passed, a printing completion cycle has to be executed to cease the operation of a printing mechanism in order to prevent a transfer mechanism from deteriorating due to idling. As a result, a preparation period is required for executing both a printing completion cycle and a printing start cycle before starting the next printing/output operation. Moreover, in the case where the printing device is connected to an external controller section including a large-capacity disk drive, and print data is transferred to the printing device for each job, the printing device is caused to cease its operation when the printing completion cycle is executed at a break between jobs. Accordingly, idle time is not negligible when successively printing a plurality of jobs.

### SUMMARY OF THE INVENTION

Therefore, an object of the present invention is to provide a printing system which allows a reduction in idle time during a printing/output operation between jobs for printing, and a job control method for such a printing system.

One aspect of the present invention is directed to a printing system comprising: a storage for temporarily storing data ready for printing; a printing section having a predetermined printing mechanism; and a job control section for controlling execution of jobs by causing the storage to store, as the data ready for printing, print data generated in units of predetermined jobs by data processing for printing, and causing the printing section to perform printing in unit of jobs based on the print data stored in the storage, wherein the job control section includes: a determination section for determining whether or not print data for a succeeding job that is to be executed after a job being printed in the printing mechanism is stored in the storage; and a notification section for, when the print data for the succeeding job is determined to be stored in the storage, notifying predetermined prediction information to the printing section, and upon receipt of the prediction information from the job control section, the printing section performs printing of the succeeding job successively after the job being printed is completed, without ceasing operation of the printing mechanism.

With this configuration, when print data for a succeeding job to be executed after a job that is being printed in the printing mechanism is stored in the storage, that is, when data used for printing the succeeding job is ready for printing, prediction information is notified to the printing section, and the printing section performs printing of the succeeding job successively after the printing of the job that is being printed is completed, without ceasing the operation of the printing mechanism. Thus, it is possible to reduce idle time during a printing/output operation between jobs for printing, thereby enhancing throughput of the printing system. Also, in the case where idle time between successive jobs is reduced in this manner, the operation of the printing mechanism is not ceased, and therefore, the operating sound is continuously generated. Thus, it is possible to achieve an effect of putting the operator at ease.

Preferably, the printing system further comprises a management memory section having stored therein print parameters indicating for each job a condition of printing based on the print data stored in the storage, wherein the job control section further includes means for determining, based on the print parameters, whether the printing mechanism requires any predetermined preparation process for starting printing the succeeding job, and when the print data for the succeeding job is determined to be stored in the storage and no preparation process is determined to be required, the notification section notifies the prediction information to the printing section.

With this configuration, predetermined prediction information is notified to the printing section only when the printing mechanism requires no predetermined preparation process for starting printing a job succeeding a job that is being printed, and even if print data for the succeeding job is stored in the storage, the prediction information is not notified when the printing mechanism requires the preparation process. Accordingly, the prediction information is notified only when the printing mechanism is able to reliably perform a successive operation for transitioning to the printing of the succeeding job, and therefore, it is possible to prevent the printing mechanism from deteriorating due to unnecessary idling.

Preferably, in the printing system, the job control section reads print data for a job to be executed from the storage and transfers the read print data to the printing section, the printing section performs printing using the printing mechanism based on the transferred print data, and when the prediction information is notified to the printing section, the job control section starts transferring the print data for the succeeding job to the printing section immediately after completion of the job being printed.

With this configuration, in a printing system including a printer as a printing section and a controller provided with a large-capacity storage device as a data storage, print data is transferred between the controller and the printer, thereby achieving an effect similar to that achieved by the printing system according to the above-described aspect of the present invention.

Preferably, in the printing system, in the case where the prediction information is received from the job control section, if the print data for the succeeding job is not transferred by a lapse of a predetermined period of time since printing of the job being printed is completed, the printing section ceases the operation of the printing mechanism.

With this structure, in the case where predetermined prediction information is received from the job control section, if the print data for the succeeding job is not transferred by a lapse of the predetermined period of time since printing of the job being printed is completed, the operation of the printing mechanism is ceased. Thus, even when data for printing the succeeding job cannot be obtained for some reason (e.g., malfunctioning), unnecessary idling of the printing mechanism can be prevented.

Preferably, in the printing system, the printing section reads print data for a job to be executed from the storage and performs printing using the printing mechanism based on the read print data.

With this configuration, in a printing system including a printer having a data storage provided therein, a printing section in the printer reads print data from the data storage, thereby making it possible to achieve an effect similar to that achieved by the printing system according to the above-described one aspect of the present invention.

Preferably, the printing system further comprises an input operation section for receiving an operation from a user, and even when the print data for the succeeding job is stored in the storage, if the input operation section receives an operation for performing a predetermined setting, the job control section retains the prediction information from being notified to the printing section.

With this configuration, when the operation for performing the predetermined setting is received by the input operation section, predetermined prediction information is retained from being notified to the printing section, thereby making it possible to, for example, allow the operator to be involved by displaying a confirmation dialog or the like immediately before starting executing a new job.

Another aspect of the present invention is directed to a job control method for a printing system, which includes a storage for temporarily storing data ready for printing, a printing section having a predetermined printing mechanism, and a job control section for controlling execution of jobs by causing the storage to store, as the data ready for printing, print data generated in units of predetermined jobs by data processing for printing, and causing the printing section to perform printing in unit of jobs based on the print data stored in the storage, the method comprising a determination step of determining whether or not print data for a succeeding job that is to be executed after a job being printed in the printing mechanism is stored in the storage; a notification step of, when the print data for the succeeding job is determined to be stored in the storage, notifying predetermined prediction information to the printing section; and a successive execution step of, upon notification of the prediction information to the printing section, allowing the printing section to perform printing of the succeeding job successively after the job being printed is completed, without ceasing operation of the printing mechanism.

Preferably, the job control method further comprises a step of determining, based on print parameters, whether the printing mechanism requires any predetermined preparation process for starting printing the succeeding job, the print parameters indicating for each job a condition of printing based on the print data stored in the storage, and when the print data for the succeeding job is determined to be stored in the storage and no preparation process is determined to be required, the notification step notifies the prediction information to the printing section.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram illustrating a hardware configuration of a printing system according to a first embodiment of the present invention;

FIG. 2 is a block diagram illustrating a configuration of functions of the printing system according to the first embodiment;

FIG. 3 is a diagram illustrating a configuration of a small table, which is a component of a management table in the first embodiment;

FIG. 4 is a diagram illustrating a configuration of the management table in the first embodiment;

FIG. 5A illustrates flowcharts of a job control process and an interruption process associated therewith in the first embodiment;

FIG. 5B illustrates flowcharts of a print control process and an interruption process associated therewith in the first embodiment;

FIG. 6 is a diagram illustrating an exemplary operation in the first embodiment;

FIGS. 7A to 7C schematic diagrams used for explaining an effect of the first embodiment;

FIG. 8 is a block diagram illustrating a hardware configuration of a printing system (printer) according to a second embodiment of the present invention;

FIG. 9 is a block diagram illustrating s configuration of functions of a printing system according to the second embodiment;

FIG. 10A is a flowchart illustrating a job control process in the second embodiment;

FIG. 10B is a flowchart illustrating a print control process in the second embodiment;

FIG. 11 is a diagram illustrating an exemplary operation in the second embodiment;

FIG. 12 is a schematic diagram illustrating an exemplary conventional printing system; and

FIG. 13 is a diagram used for explaining a problem with a conventional printing system.

### DESCRIPTION OF THE PREFERRED EMBODIMENTS

Hereinafter, embodiments of the present invention will be described with reference to the accompanying drawings.

### 1. First Embodiment

1.1 Printing System

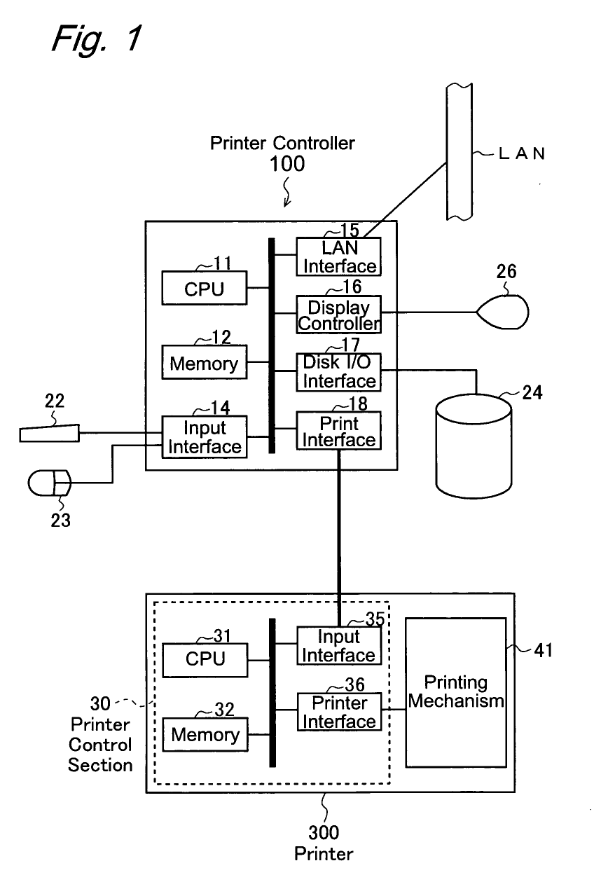

FIG. 1 is a block diagram illustrating a hardware configuration of a printing system according to a first embodiment of the present invention. This printing system includes an electrophotographic printer 300 and a computer (hereinafter, referred to as a “printer controller”) 100 as a controller for the printer 300.

The printer controller 100 of the present embodiment is implemented using a personal computer, and includes hardware components, such as a personal computer main unit, input devices (e.g., a keyboard 22 and a mouse 23), a hard disk drive 24, which is a large-capacity auxiliary storage device, and a display device 26 (e.g., a liquid crystal display or a CRT). The personal computer main unit includes: a central processing unit (CPU) 11; a memory 12 composed of a RAM, ROM, or the like, and used for program storage and work; an input interface section 14 for connecting the keyboard 22 and the mouse 23 to the printer controller 100; a LAN/IF section 15 for connecting the printer controller 100 to a LAN (Local Area Network); a display controller 16 to which the display device 26 is connected; a disk I/O interface section 17 for connecting the hard disk drive 24 to the printer controller 100; and a printer interface section 18 for connecting the printer controller 100 to the printer 300.

The printer 300 of the present embodiment includes an electrophotographic printing mechanism 41 and a printer control section 30 for controlling the printing mechanism 41. The printer control section 30 includes: a central processing unit (CPU) 31; a memory 32 composed of a RAM, ROM, or the like, and used for program storage and work; an input interface section 35 for connecting the printer controller 100 to the printer 300; and a print interface section 36 for connecting the printing mechanism 41 and the printer control section 30.

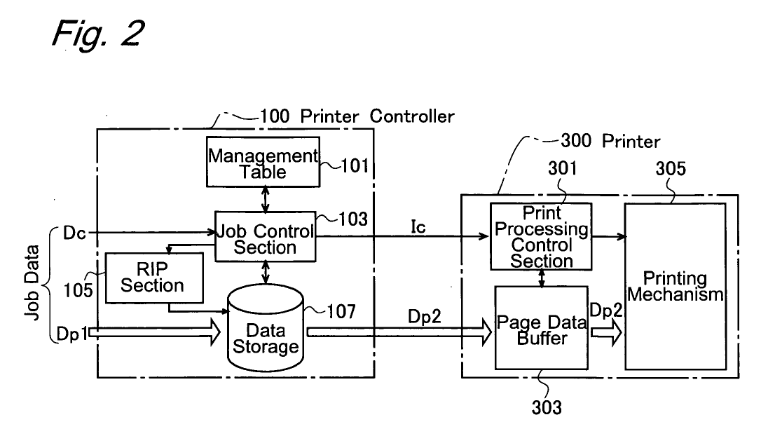

In the printing system as configured above, the CPU 11 in the printer controller 100 executes a first prescribed program, and the CPU 31 in the printer 300 executes a second prescribed program, so that the printer controller 100 and the printer 300 operate as a system functionally configured as shown in FIG. 2. Specifically, the printer controller 100 includes functional components, such as a management table 101, a job control section 103, a RIP (Raster Image Processor) section 105, and a data storage 107. The management table 101 is generated in the memory 12 or the hard disk drive 24 based on software processing by the CPU 11, and the data storage 107 is implemented by the hard disk drive 24. On the other hand, the printer 300 has functional components, such as a print processing control section 301, a page data buffer 303, and a printing mechanism 305. The print processing control section 301 is implemented by software processing by the CPU 31, the page data buffer 303 is implemented by the memory 32, and the printing mechanism 305 corresponds to the printing mechanism 41 as an element of the hardware configuration as shown in FIG. 1.

In the thus-configured printing system, the printer controller 100 receives page description data Dp1, which is generated by a front end (not shown) for use in input and edit processing and successively transferred in units of jobs together with control information Dc via a LAN. Then, the page description data Dp1 is stored into the data storage 107, and the control information Dc is inputted to the job control section 103. Herein, the printing of a predetermined number of copies of a document (such as a publication) that is to be executed in a printing system is considered as a unit of work, which is referred to as a “job”.

When the page description data Dp1 is inputted in units of jobs as described above, the CPU 11 carries out a prescribed management process (not shown) to generate, in the memory 12 or the data storage 107, a management table 101 for controlling the printing that is executed in units of jobs based on print data stored in the data storage 107 (i.e., the later-described small table corresponding to an input job is added).

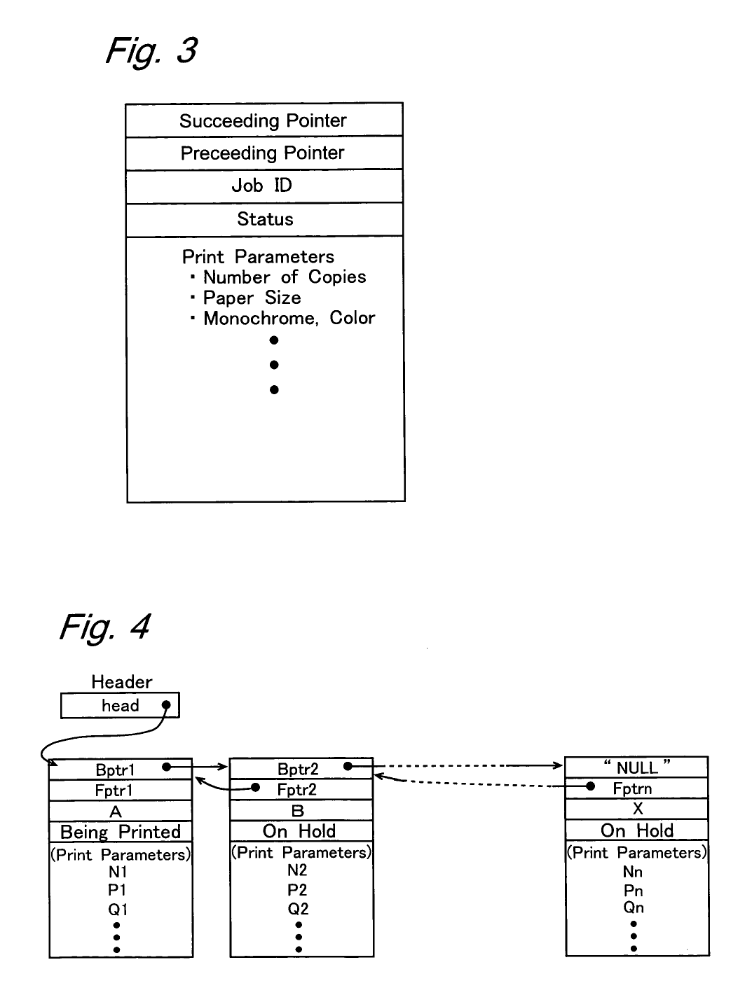

The management table 101 is implemented as a doubly-linked list as shown in FIG. 4, which includes, as its component, a small table corresponding to a single job as shown in FIG. 3. Specifically, as shown in FIG. 3, the small table corresponding to a single job includes: a storage area for a “succeeding” pointer, which is a pointer indicating a small table for an immediately succeeding job (hereinafter, referred to as a “succeeding job”) in a queue for execution of printing (execution of jobs) by the printer 300; a storage area for a “preceding” pointer, which is a pointer indicating a small table for an immediately preceding job (hereinafter, referred to as a “preceding job”) in the queue; a storage area for a job ID for identifying the single job; a storage area for a status indicating the state of the single job (e.g., on hold, being printed, or printing completed); and a storage area for print parameters indicating printing conditions (parameters indicating the number of copies to be printed, paper size, etc.). The above-mentioned doubly-linked list representing the queue as shown in FIG. 4 is configured by assigning the above-configured small table for each job and setting values corresponding to the job in the storage areas. Note that the doubly-linked list includes a header provided as an area for storing a pointer indicating the first small table in the doubly-linked list. Also, in response to input of a new job, completion of printing an existing job or job cancellation, the aforementioned management process adds/deletes a small table corresponding to the job to/from the doubly-linked list as the management table 101 (here, the management process is executed independently and concurrently with a job control process).

The job control section 103 refers to the management table 101 and controls the RIP section 105 to perform rasterization processing on page description data stored in units of jobs in the data storage 107, thereby generating print data Dp2 ready for printing, which is temporarily stored into the data storage 107. Further, the job control section 103 refers to the management table 101, and transfers the print data Dp2 from the data storage 107 to the printer 300 as well as, when a predetermined condition is satisfied, transfers the later-described successive instruction Ic as prediction information to control the printer 300, so as to perform printing in units of jobs. Here, the print data Dp2 and the successive instruction Ic are transferred via the above-described printer interface section 18 and input interface section 35 (see FIG. 1).

The print data Dp2, which has been transferred by the job control section 103 from the data storage 107 to the printer 300, is temporarily stored into the page data buffer 303. Also, the successive instruction Ic, which has been transferred from the job control section 103 to the printer 300, is inputted to the print processing control section 301. The print processing control section 301 controls the printing mechanism 305 to perform printing based on the print data Dp2 temporarily stored in the page data buffer 303. In this case, the print processing control section 301 controls the printing mechanism to perform printing in units of jobs in response to the transfer of the print data Dp2 from the printer controller 100 and with consideration of the presence or absence of the successive instruction Ic (detailed description will be given below).

1.2 Processing for Job Control and Print Control

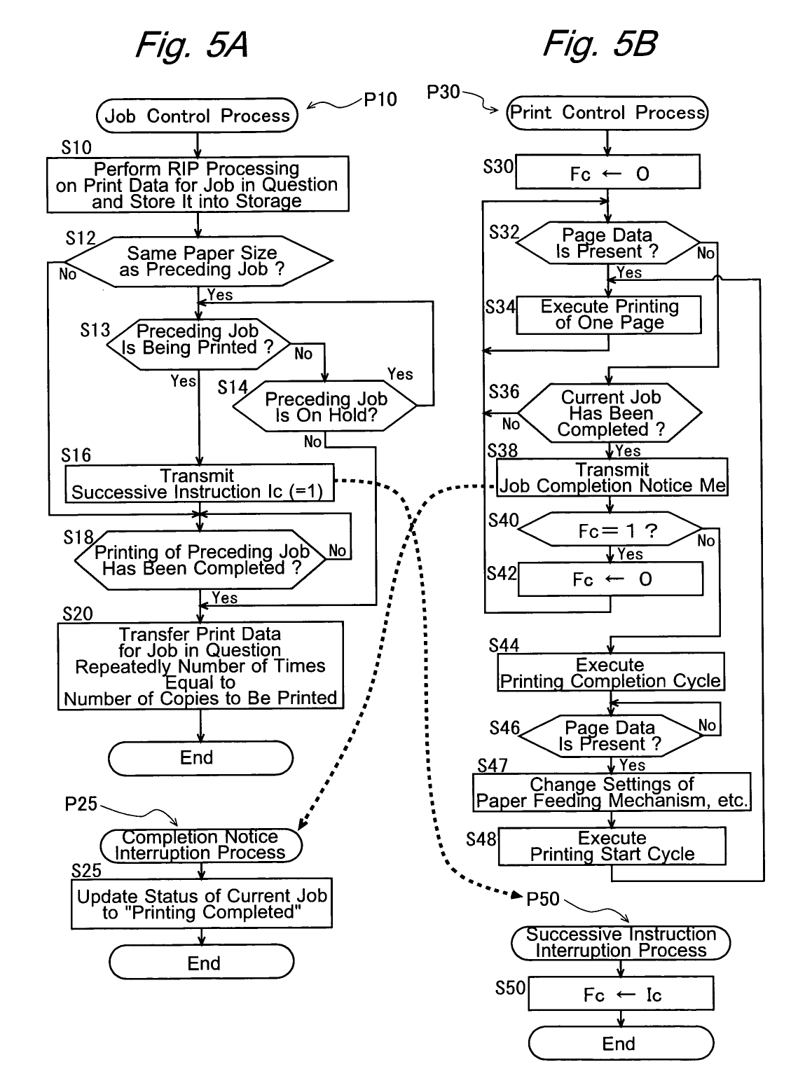

FIG. 5A illustrates flowcharts of a job control process P10 and a completion notice interruption process P25, which are executed by the CPU11 in the printer controller 100 for implementing the job control section 103. As described above, the print data Dp1, which is page description data successively inputted from an external computer, such as a front end, via a LAN, is stored in units of jobs into the data storage 107, and jobs corresponding to printing based on the print data Dp1 are managed by the management table 101, which is configured as a doubly-linked list as shown in FIG. 4 consisting of a set of small tables, to form a queue for print processing by the printer 300. A job placed at the top of the queue is normally being printed, and a plurality of jobs including the job that is being printed are successively retrieved from the top of the queue. For each job in the group of retrieved jobs (hereinafter, referred to as a “top job group”), the CPU 11 executes a job control process as shown in FIG. 5A. Then, the job control section 103 is implemented by concurrent processing in accordance with a processing task for each job in the top job group. Note that the job control process P10 is activated for each job by the above-described management process with reference to the management table 101.

Hereinbelow, the operation performed by the CPU 11 during the above-described job control process for implementing the job control section will be described with reference to FIG. 5A. When the job control process is activated for a job in the top job group (hereinafter, referred to as “the job in question”), the CPU 11 operates as follows.

First, the CPU 11 performs rasterization processing on page description data for the job in question to obtain RIP-processed data, which is stored, as print data Dp2 ready for printing, into the data storage 107 (step S10).

Next, the CPU 11 refers to the management table 101 (more specifically, print parameters in small tables for the job in question and its preceding job (FIG. 3)) and determines whether or not the paper size for the job in question is the same as the paper size for the preceding job (step S12). As a result, if they are the same in paper size as each other, the control proceeds to step S13; otherwise, the control proceeds to step S18.

At step S13, the CPU 11 determines whether the preceding job is being printed or not. If the preceding job is being printed, the CPU 11 transmits to the printer 300 (specifically, the print processing control section 301 therein) a successive instruction Ic (=1) as prediction information about printing of the job in question corresponding to a job succeeding the preceding job (step S16). Thereafter, the control proceeds to step S18.

As a result of the determination at step S13, if the preceding job is not being printed, the CPU 11 determines whether the preceding job is on hold or not (step S14). If the preceding job is on hold, the control returns to step S13. Thereafter, steps S13 to S14 are repeatedly executed while the preceding job is not printed but on hold. During this, if the preceding job is determined as being printed, the successive instruction Ic as the prediction information is transmitted to the printer 300 (step S16), and the control proceeds to step S18. On the other hand, if the preceding job is determined not to be on hold, the printing of the preceding job is considered to have been completed, and the control proceeds to step S20.

At step S18, the CPU 11 refers to the small table of the preceding job (FIG. 3) for its status and determines whether the printing of the preceding job has been completed or not. As a result, if the printing of the preceding job has been completed, the control proceeds to step S20; otherwise, the CPU 11 waits until the printing is completed, and the control proceeds to step S20 upon completion of the printing.

At step S20, the CPU 11 refers to the small table of the job in question (FIG. 3) for its print parameters, and performs the operation of reading the print data Dp2 for the job in question from the data storage 107 and transferring the read data to the printer 300. This operation is repeated the number of times equal to the number of copies to be printed. As will be described later, the printer 300 performs printing in response to the transfer of the print data Dp2, i.e., printing of the job in question. Upon completion of such transfer of the print data Dp2 for the job in question, the job control process for a single job (job in question) is completed.

FIG. 5B illustrates flowcharts of a print control process P30 and a successive instruction interruption process P50, which are executed by the CPU 31 in the printer 300 for implementing the print processing control section 301. Specifically, when the printer 300 is turned on, the CPU31 operates in a manner as described below, thereby implementing the print processing control section 301 as software.

The present embodiment employs a flag (hereinafter, referred to as a “successive conditional flag”) Fc introduced to indicate whether or not to print a succeeding job successively after the completion of printing a preceding job, without ceasing the operation of the printing mechanism 305. In the print control process, first, the CPU 31 initializes the successive conditional flag Fc to “0”. Next, the CPU 31 determines whether or not page data is present in the page data buffer 303, i.e., whether or not print data Dp2 transferred from the printer controller 100 is stored as page data in the page data buffer 303 (step S32). As a result, if the page data is present, the CPU 31 controls the printing mechanism 305 to print one page based on the page data (step S34). After one page is printed, page data corresponding to that page is deleted from the page data buffer 303 (i.e., a memory area for the page data is released). Thereafter, the control returns to step S32, and steps S32 to S34 are repeatedly performed while any page data is present in the page data buffer 303. Accordingly, the printing mechanism 305 successively print one page after another until no page data is left in the page data buffer 303, and the control proceeds to step S36 when no page data is present.

At step S36, the CPU 31 determines whether the current job, which is a job being printed, has been completed or not, i.e., whether or not the page that has been printed by the latest execution of step S34 is the final page that is to be printed in the current job (step S36). As a result, if the current job has not been completed, the control returns to the above step S32; otherwise, the CPU 31 transmits a job completion notice Me to the printer controller 100 (step S38).

When the printer controller 100 receives the job completion notice Me, the CPU 11 executes a completion notice interruption process P25 (FIG. 5A) to update the status of the current job from “being printed” to “printing completed” (step S25). The status is referred to for determining whether or not the printing of the preceding job has been completed at step S18 of the job control process P10. Also, in the above-described management process, the status is referred to for updating the value of the header of the doubly-linked list in FIG. 4 such that a small table indicated by a “succeeding” pointer in a small table for a job indicating “printing completed” is placed on the top of all small tables listed in the doubly-linked list. This means that the job indicating “printing completed” is removed from the queue for print processing.

When the current job is completed in a manner as described above, the CPU 31 determines whether the successive conditional flag Fc is set or not (step S40), and if the successive conditional flag Fc is not set (i.e., in the case other than Fc =1), the control proceeds to step S44, where the printing mechanism 305 is controlled to cease its operation after executing a printing completion cycle. Thereafter, the CPU 31 waits until any page data is stored into the page data buffer 303 (step S46). While waiting, if page data for the next job is stored (if any page data is present), the CPU 31 changes the settings of paper feeding and paper passing mechanisms for adaptation to the paper size for the next job (step S47). Thereafter, the CPU 31 controls the printing mechanism 305 to execute a printing start cycle, and the control proceeds to step S34, where the next job is printed as a new current job based on the print data Dp2 stored as page data in the page data buffer 303.

On the other hand, if the successive conditional flag is determined to be set at step S40 (in the case where Fc =1), the successive conditional flag Fc is reset (step S42), and the control proceeds to step 32, where the next job is printed as a new current job based on the print data Dp2 stored as page data in the page data buffer 303. In this manner, if the successive conditional flag Fc is set, the new current job is printed without controlling the printing mechanism 305 to execute either the printing completion cycle or the printing start cycle.

Here, when the print control process is activated (step S30), the successive conditional flag Fc is reset, and when the CPU 31 in the printer 300 executes the successive instruction interruption process P50 in FIG. 5B upon transmission of the successive instruction Ic (=1) in the above-described job control process (step S16), the successive conditional flag Fc is set (step S50). Specifically, upon transmission of the successive instruction Ic (=1), the successive instruction interruption process P50 receives the successive instruction Ic and substitutes the value thereof (“1”) into the successive conditional flag Fc to set the successive conditional flag (Fc=1). Accordingly, when the preceding job being printed and its succeeding job are the same in paper size, the successive conditional flag Fc is set.

1.3 Exemplary Operation

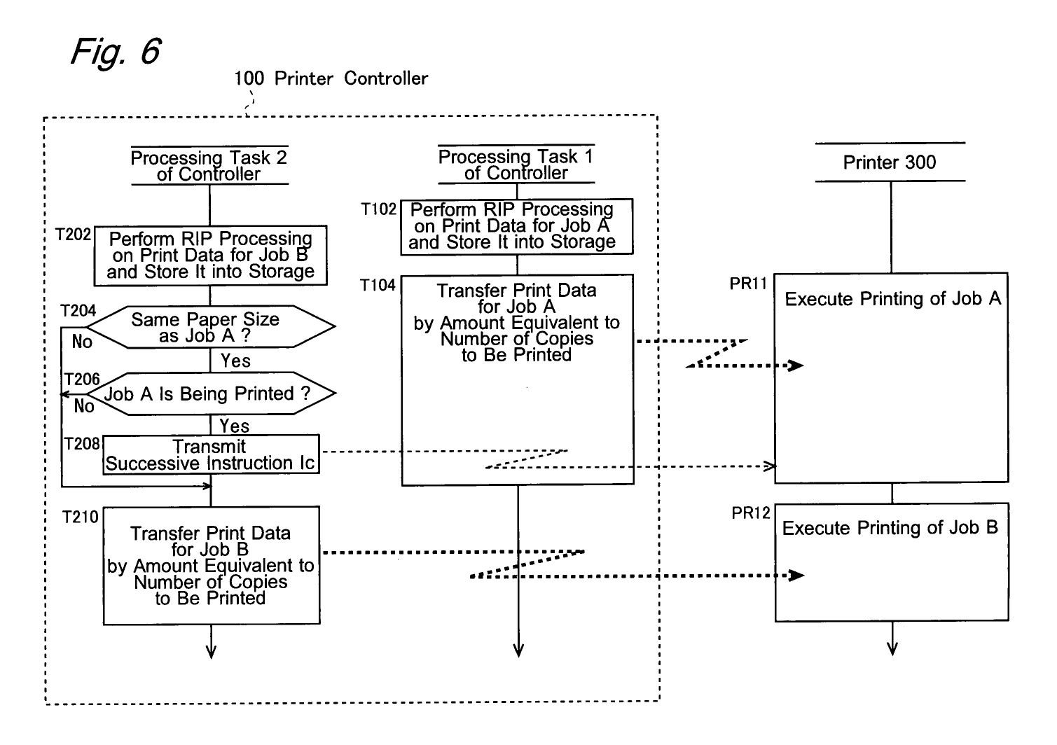

Next, an exemplary operation of the printing system according to the present embodiment is described with reference to FIG. 6. Note that the top-to-bottom direction in FIG. 6 corresponds to the direction of time progression. Now, consider a case where job control is performed by processing a processing task 1, which corresponds to execution of the above job control process P10 for job A (preceding job) that is being printed, concurrently with a processing task 2, which corresponds to execution of the above job control process P10 for job B (succeeding job) that is to be executed after the job A.

In this case, RIP processing is performed on print data for the job A, which is page description data inputted from, for example, a front end to the printer controller 100, and the RIP-processed data is stored, as print data ready for printing, into the data storage 107 (T102). Next, the print data is transferred by an amount equivalent to the number of copies to be printed from the printer controller 100 to the printer 300 (T104). In the printer 300, the print processing control section 301 controls the printing mechanism 305 to print the job A in response to the transfer of the print data (PR11).

Processing of the job B is executed concurrently with the processing of the job A as described above. Specifically, in the processing task 2, which is executed concurrently with the transfer and so on of the print data for the job A (T104), RIP processing is performed on print data for the job B, which is page description data inputted from, for example, a front end, and the RIP-processed data is stored, as print data ready for printing, into the data storage 107 (T202). Also, concurrently with the transfer of the print data for the job A (T104), it is determined whether or not the paper size for the job B is the same as the paper size for the job A (T204). Further, if the paper size for the job B is the same as that for the job A, it is determined whether the job A is being printed or not (T206). As a result, if the paper size for the job B is the same as that for the job A and the job A is being printed, the successive instruction Ic (=1) is transmitted to the printer 300 (specifically, the print processing control section 301 therein) (T208). In this exemplary operation, the successive instruction Ic (=1) is transmitted to the printer 300 on the premise that the paper size for the job B is the same as that for the job A and that the job A is being printed.

After the transfer of the print data for the job A (T104) and the printing of the job A (PR11) are completed, the data for the job B, which is stored as data ready for printing in the data storage 107, is transferred by an amount equivalent to the number of copies to be printed from the printer controller 100 to the printer 300 (T210). By the time the transfer of the print data for the job B is started, the printer 300 already receives the successive instruction Ic (=1), and therefore, the job B is printed without ceasing the operation of the printing mechanism 305 (without executing the printing completion cycle and the printing start cycle) after the printing of the job A as a preceding job is completed (PR12).

Note that in the processing task 2, if the paper size for the job A is not the same as that for the job B, or if the job A is not being printed, the transfer of the print data for the job B (T210) is started without transmitting the successive instruction Ic (=1). In such a case, the printer 300 receives no successive instruction Ic (=1), and therefore, after the printing of the job A is completed, the printing mechanism 305 executes a printing completion cycle before ceasing its operation and changing the settings of the paper feeding and paper passing mechanisms for adaptation to the paper size for the job B, for example. Thereafter, when the print data for the job B as a succeeding job is transferred (when the print data for the job B is stored as page data into the page data buffer), a printing start cycle is executed to start printing the job B (PR12).

1.4 Advantageous Effect

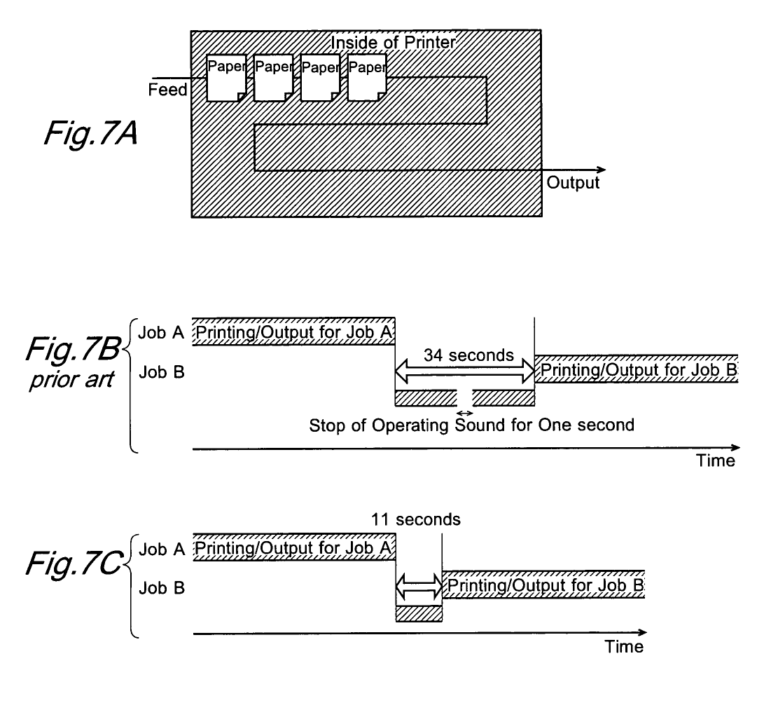

In the present embodiment as described above, when a preceding job is being printed, if print data for a succeeding job is subjected to rasterization processing and stored as date ready for printing into the data storage 107, a successive instruction Ic (=1) is transmitted to the printer 300 on the condition that the paper size for the succeeding job is the same as the paper size for the preceding job. In accordance with the successive instruction Ic (=1), the printer 300 executes printing of the succeeding job successively after completion of printing the preceding job, without ceasing the operation of the printing mechanism 305. Thus, it is possible to achieve an effect of reducing idle time during a printing/output operation between jobs for printing. Hereinbelow, such an effect of the present embodiment is described in detail with reference to FIGS. 7A to 7C and in comparison with a conventional example.

For executing printing of each job, as shown in FIG. 7A, sheets of paper are externally supplied to the printer in succession, and printing is executed while the sheets of paper are successively passed through a transfer path within the printer, so that sheets of printed paper are outputted from the printer. In conventional printing systems, for example, as shown in FIG. 7B, 34 seconds of idle time (i.e., a period of time for which no printing/output operation is carried out) is spent after job A as a preceding job is printed to output a sheet of printed paper until printing of job B as a succeeding job is started. Further, in this idle time, after a printing completion cycle is executed, the operation (mechanical operation) of the printing mechanism 305 is ceased, and no operating sound is generated (e.g., the time period for which the operating sound is stopped is one second). Thereafter, when print data for the job B is transferred, a printing start cycle is executed, and then a printing/output operation for the job B is started.

On the other hand, in present embodiment, for example, as shown in FIG. 7C, 11 seconds of idle time (i.e., a period of time for which no printing/output operation is carried out) is spent after a printing/output operation for job A as a preceding job is completed until printing of job B as a succeeding job is started, and therefore, the idle time is considerably reduced compared to the conventional systems. Moreover, in this idle time, the operation of the printing mechanism 305 is not ceased, and the operating sound is continuously generated. Note that in order to continuously generate the operating sound during the idle time, uninterrupted operation may be maintained by, for example, employing a cleaning cycle as in electrophotographic systems to prevent damage to a toner transcription section, etc.

As described above, according to the present embodiment, it is possible to reduce the idle time during a printing/output operation between jobs for printing, thereby enhancing throughput of the printing system. Also, in the case where idle time between successive jobs is reduced in a manner as described above, the operation (mechanical operation) of the printing mechanism 305 is not ceased, and therefore, the operating sound is continuously generated. Thus, it is possible to achieve an effect of putting the operator at ease.

### 2. Second Embodiment

2.1 Printing System

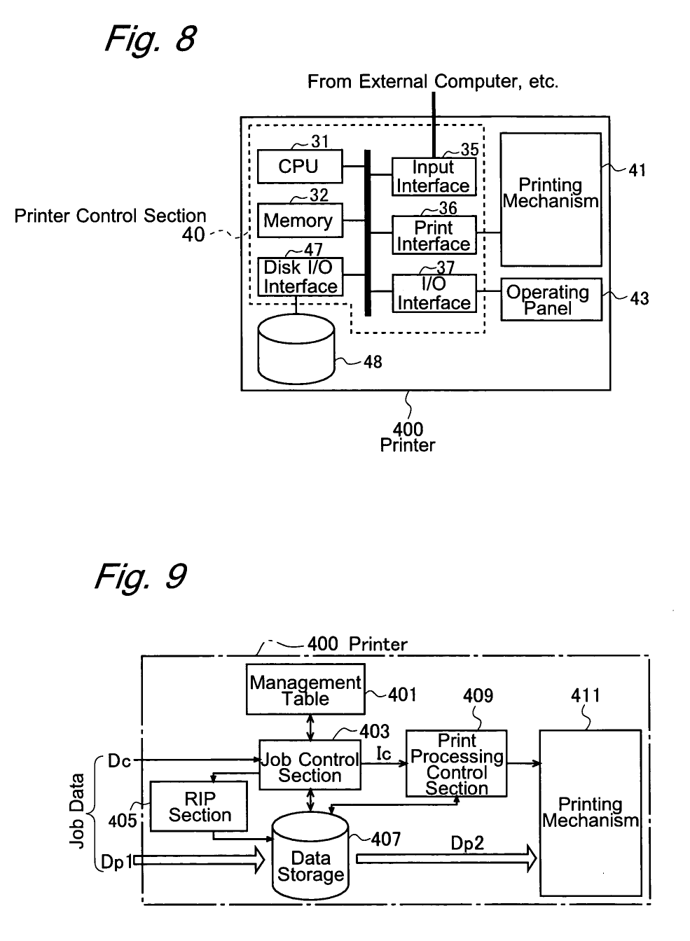

FIG. 8 is a block diagram illustrating a hardware configuration of a printer 400, which is a printing system according to a second embodiment of the present invention. The printer 400 includes an electrophotographic printing mechanism 41, a printer control section 40 for controlling the printing mechanism 41, an operating panel 43 for receiving the operator's operation, and a hard disk drive 48 as an auxiliary storage device. The printer control section 40 includes: a central processing unit (CPU) 31; a memory 32 composed of a RAM, ROM, or the like, and used for program storage and work; an input interface section 35 for connecting the printer 400 to an external computer such as a front end for use in input and edit processing; a printing interface section 36 for connecting the printing mechanism 41 to the printer control section 40; and a disk I/O interface section 47 for connecting the hard disk drive 48 to the printer control section 40. Note that in the present embodiment, the hard disk drive 48 included in the printer 400 has a smaller capacity compared to the hard disk drive 24 of the controller 100 in the first embodiment, and therefore, cannot store RIP-processed print data for a large number of jobs.

In the printer 400 as described above, the CPU 31 executes a prescribed program, so that the printer 400 as a printing system according to the present embodiment operates as an apparatus functionally configured as shown in FIG. 9. Specifically, the printer 400 includes functional components, such as a management table 401, a job control section 403, a RIP section 405, a data storage 407, a print processing control section 409, and a printing mechanism 411. The management table 401 is generated in the memory 32 or the hard disk drive 48 based on software processing by the CPU 31, and the data storage 407 is implemented by the hard disk drive 48. Also, the print processing control section 409 is implemented by software processing by the CPU 31, and the printing mechanism 411 corresponds to the printing mechanism 41 as an element of the hardware configuration as shown in FIG. 8.

To the printer 400 as configured above, page description data Dp1 generated by input and edit processing is successively inputted in units of jobs together with control information Dc from an external computer such as a front end. Then, the page description data Dp1 is stored into the data storage 407, and the control information Dc is inputted to the job control section 403. At this point in time, the CPU 31 performs a prescribed management process (not shown) to generate, in the memory 32 or the data storage 407, a management table 401 for controlling execution of printing in units of jobs based on the print data Dp1 stored in the data storage 407 (more specifically, for each input of a job, a small table corresponding to the inputted job is added to a doubly-linked list). The configuration of the management table 401 is substantially the same as the management table 101 in the first embodiment, and therefore, the description thereof is omitted herein (see FIGS. 3 and 4).

The job control section 403 refers to the management table 401 and controls the RIP section 405 to perform rasterization processing on the page description data Dp1 stored in units of jobs in the data storage 407, thereby generating print data Dp2 ready for printing, which is temporarily stored in the data storage 407. Further, when a predetermined condition is satisfied, the job control section 403 notifies the print processing control section 409 of a successive instruction similar to that as described in the first embodiment. The print processing control section 409 controls the printing mechanism 411 to perform printing in units of jobs based on the print data Dp2 temporarily stored in the data storage 407 with consideration of the presence or absence of notification of the successive instruction (detailed description will be given below).

2.2 Processing for Job Control and Print Control

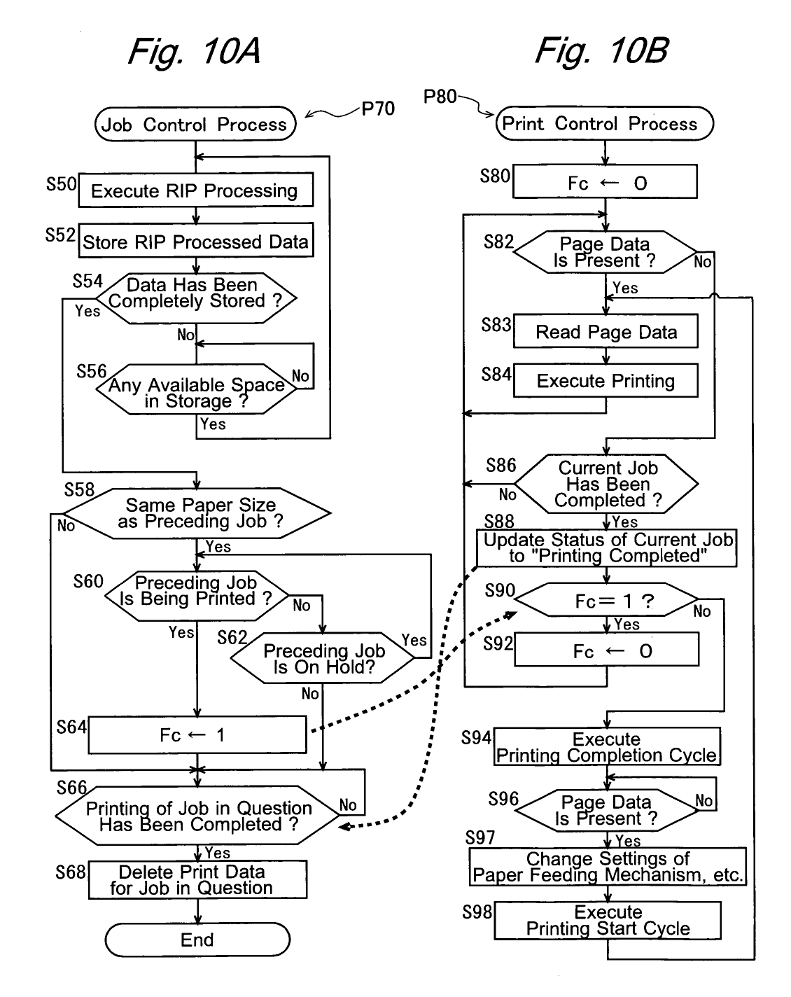

FIG. 10A is a flowchart illustrating a job control process P70 executed by the CPU 31 in the printer controller 400 for implementing the job control section 403. As described above, print data Dp1, which is page description data successively inputted from an external computer such as a front end for use in input and edit processing, is stored in units of jobs into the data storage 407, and jobs corresponding to printing based on the print data Dp1 are managed with the management table 101, which is configured as a doubly-linked list as shown in FIG. 4 consisting of a set of small tables, to form a queue for print processing by the printer 400. A job placed at the top of the queue is normally being printed, and a plurality of jobs including the job that is being printed are successively retrieved from the top of the queue. For each job in the group of retrieved jobs (hereinafter, referred to as a “top job group”), the CPU 31 executes a job control process as shown in FIG. 10A. Then, the job control section 403 is implemented by concurrent processing in accordance with a processing task for each job in the top job group.

Hereinbelow, the operation performed by the CPU 31 during the above-described job control process for implementing the job control section 403 will be described with reference to FIG. 10A. When the job control process is activated for a job in the top job group (hereinafter, referred to as “the job in question”), the CPU 31 operates as follows.

First, the CPU 31 performs rasterization processing in predetermined units on page description data for the job in question (step S50), and stores resultant RIP-processed data into the data storage 407 (step S52). Next, the CPU 31 determines whether or not print data for the job in question has been completely stored as RIP-processed data Dp2 into the data storage 407 (step S54). As a result, if the print data for the job in question is determined not to have been completely stored as the RIP-processed data Dp2, the CPU 31 waits until any space in the data storage 407 becomes available for completely storing the RIP-processed data (step S56). When any space is made available, the control returns to step S50. Thereafter, steps S50 to S56 are repeatedly performed until the print data for the job in question is completely stored as the RIP-processed data Dp2 into the data storage 407. When the print data for the job in question is completely stored as the RIP-processed data Dp2, the control proceeds to step S58.

At step S58, the CPU 31 refers to the management table 401 (more specifically, print parameters in small tables for the job in question and its preceding job (FIG. 3) ) and determines whether or not the paper size for the job in question is the same as the paper size for the preceding job (step S58). As a result, if they are the same in paper sizes as each other, the control proceeds to step S60; otherwise, the control proceeds to step S66.

At step S60, the CPU 31 determines whether the preceding job is being printed or not. If the preceding job is being printed, the CPU 31 sets a flag, i.e., a successive conditional flag Fc (Fc=1), for notifying a successive instruction as prediction information about printing of the job in question corresponding to a job succeeding the preceding job (step S64). Thereafter, the control proceeds to step S66. Note that the successive conditional flag Fc is employed for a similar purpose to the successive conditional flag in the first embodiment, and referred to in a print control process P80, which will be described later.

As a result of the determination at step S60, if the preceding job is not being printed, the CPU31 determines whether the preceding job is on hold or not (step S62). If the preceding job is on hold, the control returns to step S60. Thereafter, steps S60 to S62 are repeatedly executed while the preceding job is not printed but on hold. During this, if the preceding job is determined as being printed, the CPU 31 sets the successive conditional flag Fc as described above (step S64), and the control proceeds to step S66. On the other hand, if the preceding job is determined not to be on hold, the printing of the preceding job is considered to have been completed, and the control proceeds to step S66.

After the control proceeds to step S66, the CPU 31 refers to the small table of the job in question (FIG. 3) for its status, and waits until printing of the job in question is completed. During this, if the printing of the job in question is completed by the later-described print control process P80, the status in the small table for the job in question (FIG. 3) is updated to “printing completed” (the later-described step S88).

After waiting until the printing of the job in question is completed at step S66, the CPU 31 deletes the print data Dp2 for the job in question from the data storage 407 in order to secure an area for storing RIP-processed data for a job succeeding the job in question (step S68). In this manner, a job control process for a single job (job in question) is completed.

FIG. 10B is a flowchart illustrating the print control process P80 executed by the CPU 31 in the printer 400 for implementing the print processing control section 409. Specifically, when the printer 400 is turned on, the CPU 31 operates in accordance with the flowchart in FIG. 10B to implement the print processing control section 409 as software.

The print control process P80 in the present embodiment is similar to the print control process P30 in the first embodiment except that RIP-processed print data Dp2 is read as page data from the data storage 407 for executing printing of each page (step S83), and that when printing of the current job, which is a job being printed, is completed, the status of the current job is updated to “printing completed” (step S88), instead of transmitting the job completion notice Me. Therefore, the detailed description of the print control process P80 in the present embodiment is omitted herein. Note that steps S80, S82, S84, S86, S90, S92, and S94 to S98 of the print control process P80 in the present embodiment correspond to steps S30, S32, S34, S36, S40, S42, and S44 to S48, respectively, of the print control process P30 in the first embodiment.

2.3 Exemplary Operation

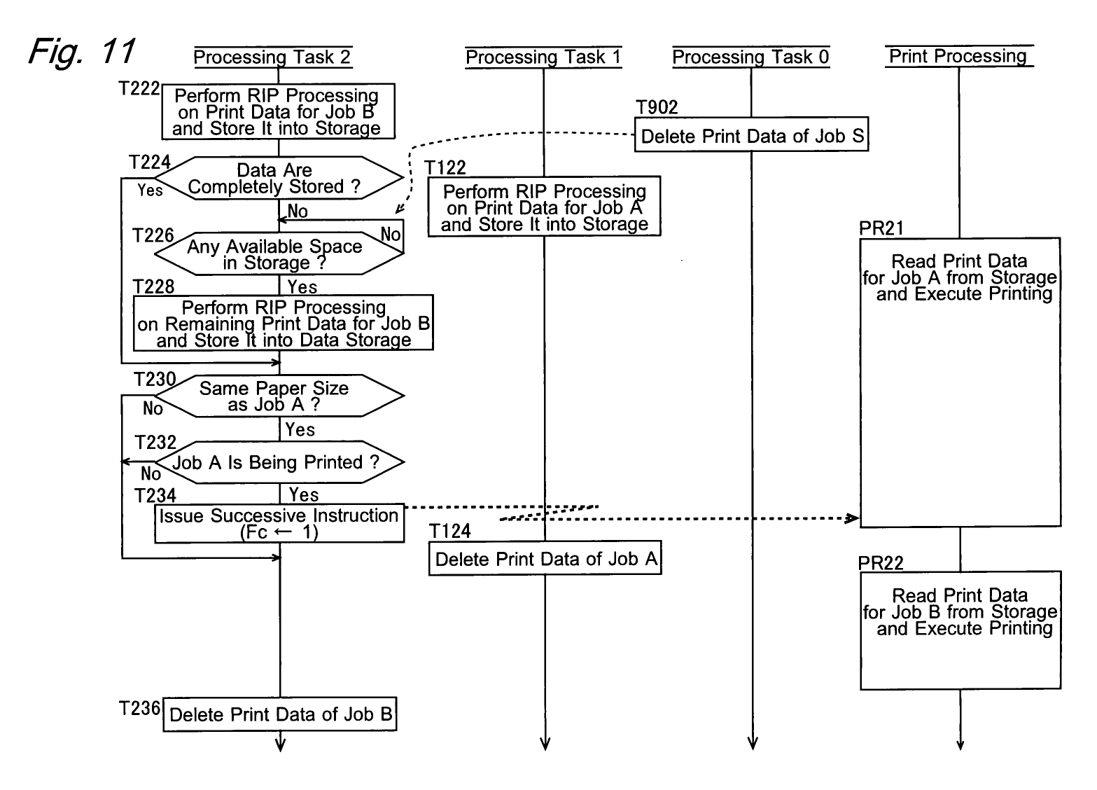

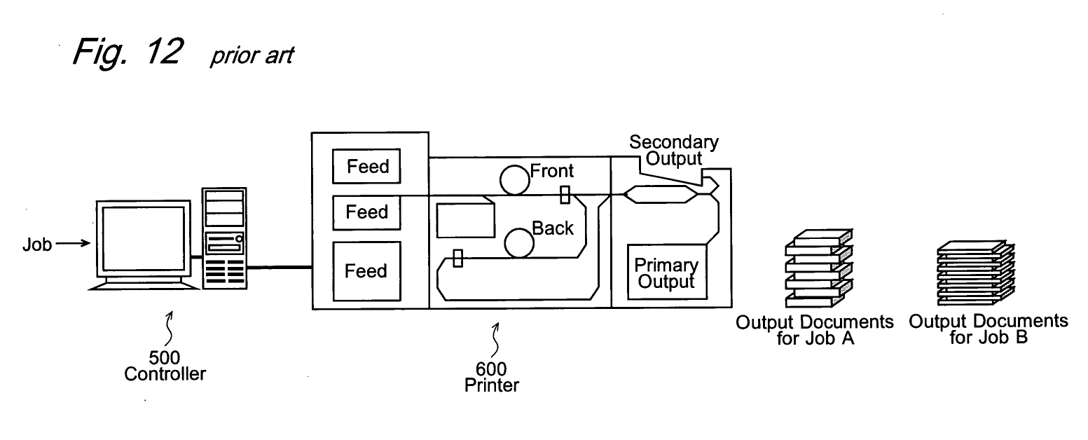

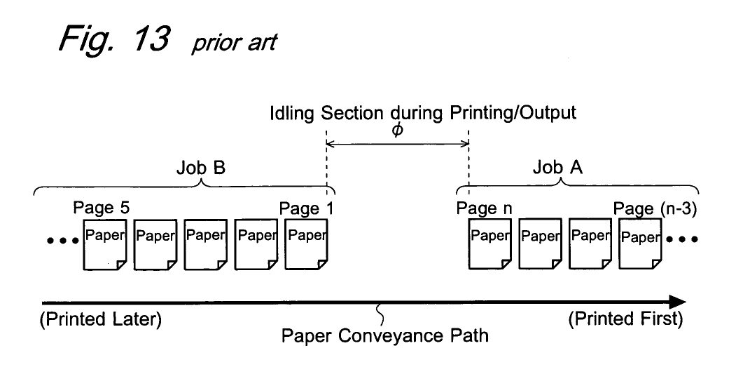

Next, an exemplary operation of the printer 400 as the printing system according to the present embodiment is described with reference to FIG. 11. Note that the top-to-bottom direction in FIG. 11 corresponds to the direction of time progression. Now, consider a case where job control of the printer 400 is carried out by performing concurrently processing tasks 0, 1, and 2 corresponding to execution of the job control process P70 for a top job group consisting of the first job S, the second job A, and the third job B in the queue as represented by the doubly-linked list in FIG. 4.

In this case, in the operation period shown in FIG. 11, printing of the job S has already been completed, and therefore, print data for the job S is deleted from the data storage 407 (T902). In the processing task 1 which is performed concurrently with the processing task 0 for the job S, print data for the job A is stored into the data storage 407 (T122). Thereafter, in the print control process P80 and processing by the printing mechanism 411 based thereon (hereinafter, the both are collectively referred to as “print processing”), the print data for the job A is read from the data storage 407, and printing is executed based on the read print data (PR21).

In the processing task 2 which is executed concurrently with the processing tasks 0 and 1, first, RIP processing is performed on print data (page description data) for the job B, and the RIP-processed print data is stored as data ready for printing into the data storage 407 (T222). At this point in time, the available space in the data storage 407 is small, and therefore, the RIP-processed print data for the job B can not be completely stored into the data storage 407. Accordingly, thereafter, the print data for the job B is determined not to have been completely stored as the RIP-processed data into the data storage 407 (T224), and the processing is placed on hold until any space in the data storage 407 becomes available (T226). However, at the beginning of the hold operation T226, the print data for the job S has been deleted by the processing task 0 (T902), and the data storage 407 has an available space. Therefore, the remaining print data (page description data) for the job B is subjected to RIP processing, and stored as print data ready for printing into the data storage 407 (T228). At this point in time of the present exemplary operation, all the remaining print data for the job B is subjected to RIP processing, and stored into the data storage 407.

Next, it is determined whether or not the paper size for the job B is the same as the paper size for the job A, which is a preceding job being printed (T230). Then, if the paper size for the job B is the same as that for the job A, it is determined whether the job A is being printed or not (T232). At this point in time of the present exemplary operation, the job A is being printed (PR21), and therefore, if the paper size for the job B is the same as that for the job A, a successive conditional flag Fc is set (Fc=1) to notify a successive instruction (T234). Accordingly, in the print processing, when the printing of the job A is thereafter completed (PR21), the printing of the job B is executed without ceasing the operation of the printing mechanism 411 (without executing the printing completion cycle and the printing start cycle) (PR22).

Note that in the processing task 1, after the printing of the job A is completed, the print data for the job A is deleted from the data storage 407 in order to secure an area for storing RIP-processed data for a job succeeding the job B (T124). Also, in the processing task 2, after the printing of the job B is completed, the print data for the job B is deleted from the data storage 407 in order to secure an area for storing RIP-processed data for another succeeding job (T236). Further, in the processing task 2, if the paper size for the job A is not the same as the paper size for the job B, the printing of the job B is started without notifying the successive instruction (PR22). In such a case, after the printing of the job A is completed, the printing mechanism 411 executes a printing completion cycle, and ceases its operation. Thereafter, when the RIP-processed print data for the job B is stored into the data storage 407, the settings of paper feeding and paper passing mechanisms are changed for adaptation to the paper size for the job B. Then, the printing mechanism 411 executes a printing start cycle, and thereafter the print data is read from the data storage 407 in accordance with the print control process P80. Based on the print data, printing of the job B is executed by the printing mechanism 411 (PR22).

2.4 Advantageous Effect

In the present embodiment as described above, the print data Dp2 for allowing the printing mechanism 411 to perform printing is passed via the data storage 407, and the successive instruction is notified by setting the successive conditional flag Fc in accordance with the job control process P70. In this regard, the present embodiment differs from the first embodiment. However, also in the present embodiment, the successive conditional flag Fc is set on the condition that the preceding job that is being printed and the succeeding job that is to be executed next are the same in paper size when print data Dp1 for the succeeding job is subjected to rasterization processing and stored as data Dp2 ready for printing into the data storage 407 during the printing of the preceding job. As in the first embodiment, the print processing control section 409 controls, based on the setting of the successive conditional flag Fc in accordance with the job control process P70, the printing mechanism 411 to perform the printing of the succeeding job successively after completion of the printing of the preceding job without ceasing the operation of the printing mechanism 411. This reduces idle time during a printing/output operation between jobs for printing, thereby enhancing throughput of the printer 400 as a printing system. Also, in the case where idle time between successive jobs is reduced in a manner as described above, the operation (mechanical operation) of the printing mechanism 411 is not ceased, and therefore, the operating sound is continuously generated. Thus, it is possible to achieve an effect of putting the operator at ease.

3. Variant

In the above first embodiment, the configuration for performing the operation as shown in FIG. 6 is implemented as software based on the job control process P10 and the print control process P30, which are shown in FIGS. 5A and 5B, respectively, and the interruption processes P25 and P50 associated therewith. In the above second embodiment, the configuration for performing the operation as shown in FIG. 11 is implemented as software based on the job control process P70 and the print control process P80, which are shown in FIGS. 10A and 10B, respectively. However, the present invention is not limited to these configurations. Any other configurations implemented by software or configurations partially implemented by hardware are applicable so long as printing of a succeeding job can be executed without ceasing the operation of the printing mechanism as described above when data for printing the succeeding job is made ready during printing of a job preceding the succeeding job, and the preceding job and the succeeding job are the same in paper size so that no preparation processes are required by the printing mechanism before starting the printing of the succeeding job.

Also, in the above first and second embodiments, the successive conditional flag Fc is set or reset in accordance with whether or not the preceding job and the succeeding job are the same in paper size. But more generally, the successive conditional flag Fc may be set or reset in accordance with whether or not the printing mechanism requires preparation processes such as changing the settings of paper feeding and paper passing mechanisms for starting printing of the succeeding job after printing of the preceding job is completed. Also, some printing mechanism requires no preparation processes for changing the paper size at the time of starting the printing of the succeeding job even if the preceding job and the succeeding job are different in paper size. In such a case, the job control section 103, 403 may be configured to notify a successive instruction as prediction information to the print processing control section 301, 409 at the time print data Dp1 for the succeeding job is subjected to rasterization processing and prepared as data Dp2 ready for printing (i.e., stored into the data storage 107, 407) during the printing of the preceding job.

Incidentally, in the above first and second embodiments, even if the successive conditional flag Fc is set (Fc=1), it is preferred to cease the operation of the printing mechanism 305, 411 when data for printing the succeeding job can not be obtained for some reason (e.g., malfunctioning of the controller 100) after printing of the preceding job is completed. For this, the step of determining the presence or absence of page data may be inserted, for example, immediately after step S40, S90, which is a determination statement for the successive conditional flag Fc, such that the processing is kept on hold with a timer active during a period of time without page data (e.g., in the case of the first embodiment, during a period of time for which print data Dp2 for the succeeding job is not transferred from the controller 100), and if no page data can be obtained while holding for a predetermined period of time (e.g., two seconds), the processing proceeds to step S44, S94, where the printing completion cycle is executed.

Also, in the above first and second embodiments, it is conceivable that the succeeding job might be cancelled after the successive instruction for the succeeding job is issued (i.e., after the successive conditional flag Fc is set), but before the preceding job is completed. Accordingly, if such cancellation occurs, it is preferred to notify the cancellation to the print processing control section 301, 409, such that the print processing control section 301, 409 resets the successive conditional flag Fc (Fc=0) in response to the notice. For this reason, in the above first embodiment, if cancellation of a job occurs, a successive instruction Ic, which has a value of “0”, may be transmitted to the print processing control section 301, for example. This resets the successive conditional flag Fc in the successive instruction interruption process P50 (step S50 in FIG. 5B).

Conversely, if the preceding job and the succeeding job are different in paper size so that no successive instruction is issued, the successive instruction may be issued by canceling the succeeding job. For example, even in the case where a queue is formed such that jobs A, B, and C are printed in this order, and the jobs A and B do not satisfy a predetermined condition (e.g., equality in paper size) so that no successive instruction is issued, the predetermined condition might be satisfied by the jobs A and C if the job B is cancelled during printing of the job A.

In order to address such a situation, in the first embodiment, the jobs that are to be processed concurrently by the job control process P10 may be limited only to two jobs, e.g., a job which is being printed and a succeeding job that is to be executed next. By doing so, only two processing tasks for the jobs A and B are in operation as job control processing tasks before the cancellation of the job B, and a job control processing task for the job C is activated upon cancellation of the job B. The activation of the processing task for the job C means that execution of the job control process P10 for the job C starts in the state where the job B is cancelled. Accordingly, at step S16 of the job control process P10, a successive instruction Ic (=1) is transmitted, and a successive conditional flag Fc is set (Fc=1) in the successive instruction interruption process P50 in response to the transmission.

Further, even if the above predetermined condition for issuing the successive instruction is satisfied, any step that involves the operator may be desirably inserted each time the job that is to be executed is changed or immediately before a predetermined job is executed. A conceivable example is a case where the setting is made for presenting a confirmation dialog to the operator before printing of each job is started. In the case where such setting is made by, for example, the operator operating an input device (e.g., a keyboard 22 and/or a mouse 23), when the above predetermined condition is satisfied, for example, in the job control process P10 of the first embodiment, a successive instruction Ic having a value of “0” may be transmitted, instead of transmitting a successive instruction having a value of “1”, in order to achieve compatibility with the setting (see step S16 in FIG. 5A). This is intended to prevent the successive instruction Ic (=1) from being transmitted as prediction information for a succeeding job. By doing so, the successive conditional flag Fc is reset in the successive instruction interruption process P50 (see step S50 in FIG. 5B), the printing mechanism ceases its operation upon completion of each job (step S44, S46). Accordingly, it is possible to display the confirmation dialog on the display device 26 of the printer controller 100 while the operation of the printing mechanism is ceased, and transfer of print data for the succeeding job may be started by the operator performing a predetermined operation after seeing the displayed confirmation dialog.

Note that in the above first and second embodiments, the printing mechanisms 305 and 411 are configured in accordance with electrophotographic technology, but the present invention is not limited to this. However, the present invention is particularly advantageous for printing systems including an electrophotographic printing mechanism. In conventional electrophotographic printing systems, even if print data Dp2 for a plurality of jobs can be stored in a disk drive, a printing completion cycle is executed to cease the operation of a printing mechanism before processing the next job in order to prevent a transfer mechanism from deteriorating due to idling. However, according to the present invention, it is possible to reduce idle time during a printing/output operation due to such cessation. Also, in the above first and second embodiments, the data storages 107 and 407 for storing print data are implemented by the hard disk drive 24, but may be implemented by the memory 12 (i.e., a semiconductor memory device such as a RAM).

While the invention has been described in detail, the foregoing description is in all aspects illustrative and not restrictive. It is understood that numerous other modifications and variations can be devised without departing from the scope of the invention.

Note that the present application claims priority based on Japanese Patent Application No. 2004-263304, titled “PRINTING SYSTEM AND JOB CONTROL METHOD THEREFOR”, filed on Sep. 10, 2004, and hereby incorporated by reference in its entirety.

What is claimed is:

1. A printing system comprising:
a storage for temporarily storing data ready for printing;
a printing section having a predetermined printing mechanism; and
a job control section for controlling execution of jobs by causing the storage to store, as the data ready for printing, print data generated in units of predetermined jobs by data processing for printing, and causing the printing section to perform printing in unit of jobs based on the print data stored in the storage, wherein
the job control section includes:
a determination section for determining whether or not print data for a succeeding job that is to be executed after a job being printed in the printing mechanism is stored in the storage; and
a notification section for, when the print data for the succeeding job is determined to be stored in the storage, notifying predetermined prediction information to the printing section, and
upon receipt of the prediction information from the job control section, the printing section performs printing of the succeeding job successively after the job being printed is completed, without ceasing operation of the printing mechanism.

2. The printing system according to claim 1, further comprising a management memory section having stored therein print parameters indicating for each job a condition of printing based on the print data stored in the storage, wherein
the job control section further includes means for determining, based on the print parameters, whether the printing mechanism requires any predetermined preparation process for starting printing the succeeding job, and
when the print data for the succeeding job is determined to be stored in the storage and no preparation process is determined to be required, the notification section notifies the prediction information to the printing section.

3. The printing system according to claim 1, wherein the job control section reads print data for a job to be executed from the storage and transfers the read print data to the printing section,
the printing section performs printing using the printing mechanism based on the transferred print data, and
when the prediction information is notified to the printing section, the job control section starts transferring the print data for the succeeding job to the printing section immediately after completion of the job being printed.

4. The printing system according to claim 3, wherein in the case where the prediction information is received from the job control section, if the print data for the succeeding job is not transferred by a lapse of a predetermined period of time since printing of the job being printed is completed, the printing section ceases the operation of the printing mechanism.

5. The printing system according to claim 1, wherein the printing section reads print data for a job to be executed from the storage and performs printing using the printing mechanism based on the read print data.

6. The printing system according to claim 1, further comprising an input operation section for receiving an operation from a user, wherein
even when the print data for the succeeding job is stored in the storage, if the input operation section receives an operation for performing a predetermined setting, the job control section retains the prediction information from being notified to the printing section.

7. A job control method for a printing system, which includes a storage for temporarily storing data ready for printing, a printing section having a predetermined printing mechanism, and a job control section for controlling execution of jobs by causing the storage to store, as the data ready for printing, print data generated in units of predetermined jobs by data processing for printing, and causing the printing section to perform printing in unit of jobs based on the print data stored in the storage, the method comprising:
a determination step of determining whether or not print data for a succeeding job that is to be executed after a job being printed in the printing mechanism is stored in the storage;
a notification step of, when the print data for the succeeding job is determined to be stored in the storage, notifying predetermined prediction information to the printing section; and
a successive execution step of, upon notification of the prediction information to the printing section, allowing the printing section to perform printing of the succeeding job successively after the job being printed is completed, without ceasing operation of the printing mechanism.

8. The job control method according to claim 7, further comprising a step of determining, based on print parameters, whether the printing mechanism requires any predetermined preparation process for starting printing the succeeding job, the print parameters indicating for each job a condition of printing based on the print data stored in the storage, wherein
when the print data for the succeeding job is determined to be stored in the storage and no preparation process is determined to be required, the notification step notifies the prediction information to the printing section.
